(19) United States
(12) Patent Application Publication
(10) Pub. No.: US 2013/0070455 A1
(43) Pub. Date: Mar. 21, 2013

(54) LED LIGHTING FIXTURE

(71) Applicants: Joseph Tsui, Edmonton (CA); Jilun Yuan, Xiamen (CN)

(72) Inventors: Joseph Tsui, Edmonton (CA); Jilun Yuan, Xiamen (CN)

(73) Assignee: CANASIA GROUP LIMITED, Kwon Tong (CN)

(21) Appl. No.: 13/460,475

(22) Filed: Apr. 30, 2012

Related U.S. Application Data
(60) Provisional application No. 61/535,754, filed on Sep. 16, 2011.

(51) Int. Cl. F21V 11/00

(52) U.S. Cl. 362/235

(57) ABSTRACT

A method of designing a lighting panel includes the steps of determining a level of lumen output to be achieved from the lighting panel, selecting one or more types of LEDs having a predetermined light intensity and light output angle, calculating the number of LEDs required to achieve the level of lumen output, and arranging the LEDs in an array. The LEDs are oriented such that the light output angle is centered on a light diffuser panel. The LEDs are spaced in the array and spaced from the light diffuser panel such that the light output from LEDs overlaps on the light diffuser panel such that the light transmitted through the diffuser panel appears consistent across the light diffuser panel to the human eye and achieves the determined level of lumen output.

### FIELD

This relates to LED light fixtures, and in particular, light fixtures with LEDs that shine directly onto a diffuser to provide a light output that is consistent to the human eye across the diffuser, and light fixtures with LEDs that can be retrofitted into existing fixtures.

### BACKGROUND

For general purpose lighting, it is common to use fluorescent bulbs installed in light fixtures. Relative to incandescent bulbs, these lights are generally longer lasting, use less energy, and generate less heat. LED lights may also be used in light fixtures.

### SUMMARY

There is provided a method of designing a lighting panel having an LED array spaced from a light diffusion panel. The method comprises the steps of determining a level of lumen output to be achieved from the lighting panel, selecting one or more types of LEDs having a predetermined light intensity and light output angle, calculating the number of LEDs required to achieve the level of lumen output, and arranging the LEDs in an array. The LEDs are oriented such that the light output angle is centered on the light diffuser panel. The LEDs are spaced in the array and spaced from the light diffuser panel such that the light output from LEDs overlaps on the light diffuser panel such that the light transmitted through the diffuser panel appears consistent across the light diffuser panel to the human eye and achieves the determined level of lumen output.

According to an aspect, the LEDs may be in a regular rectangular array.

According to an aspect, the LEDs may be spaced closer in a first direction than in a second direction.

According to an aspect, the spacing of the LEDs in a first direction may be within 10% of the spacing of the LEDs in a second direction.

According to an aspect, the LEDs may be connected to a common power supply.

According to an aspect, the LED array may define a plane.

According to an aspect, the diffuser panel may define a curved surface.

According to an aspect, the LED array may define a rectangular shape or a curved shape.

According to an aspect, the LED array may be mounted to a modular substrate.

According to an aspect, there is provided a lighting panel having an LED array manufactured using the above steps.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an exploded perspective view of a light fixture.

FIG. 2 is a top perspective view of a light fixture.

FIG. 3 is a bottom perspective view of a light fixture.

FIG. 4 is an exploded view of a LED light panel that is installed within the light fixture.

FIG. 5 is a top plan view of a LED light panel that is installed within the light fixture.

FIG. 6 is a detailed view of a corner of the LED light panel.

FIG. 7 is a side elevation view in section of a portion of a light fixture.

FIG. 8 is a top plan view of the light distribution of a LED light panel.

FIG. 9 is a perspective view of an alternative light fixture.

FIG. 10 is a perspective view of a power driver.

FIG. 11 is a perspective view of a LED light panel.

FIG. 12 is a perspective view of a power driver driving an array of LED light panels.

FIG. 13 is an exploded perspective view of a retrofitted light fixture.

FIG. 14 is a perspective view of a retrofitted light fixture.

FIG. 15 is a side elevation view of an alternatively mounted LED light panel.

### DETAILED DESCRIPTION

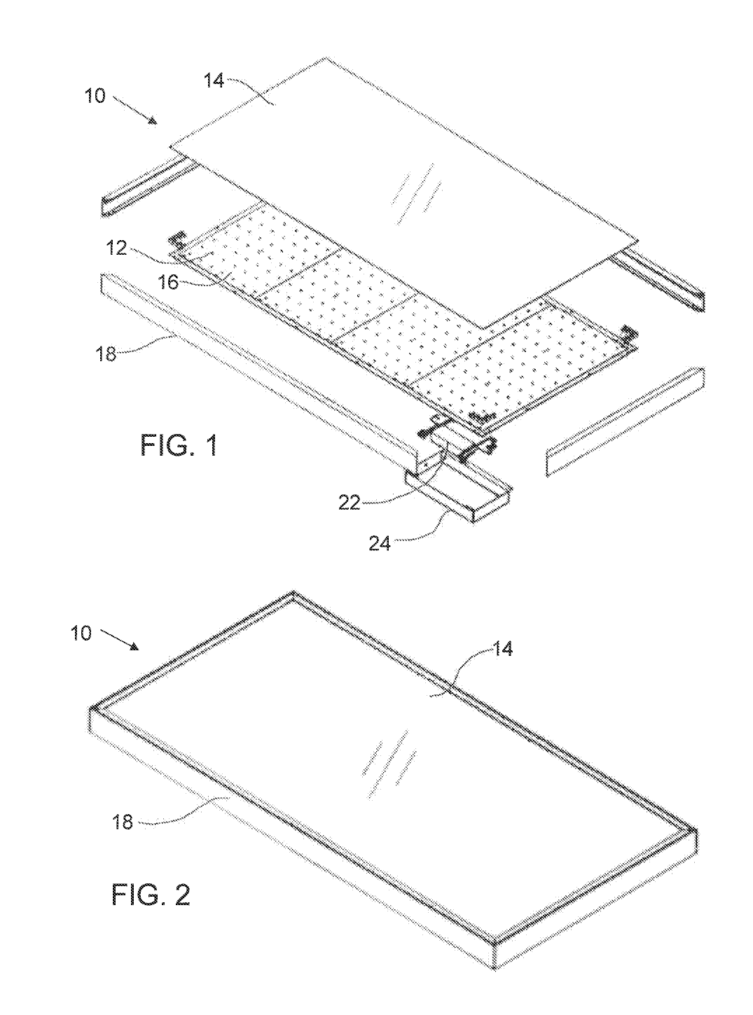

Referring to FIG. 1, LED light fixtures, generally indicated by reference numeral 10, include a panel 16 with an array of LED lights 12 supported above a light diffusing layer 12, such that LEDs 12 are oriented directly toward light diffusing layer 12, causing the light emitted from LEDs 12 to shine directly onto light diffusing layer 12. The design and spacing of the array of LEDs 12 as well as the distance above light diffusing layer 12 is such that the light diffusing layer emits light that appears to be continuous to the human eye while providing the desired amount of light output. When using LEDs for general purpose lighting and when the LEDs shine directly toward the area to be lit, the required luminance from each LED creates a point source of light that can be irritating or harmful to a person's eyes. By using the principles described herein, direct-shining LEDs may be used to create a light source that is not harmful or irritating. This improves the efficiency of the lighting fixture and decreases the manufacturing cost. While FIG. 1 depicts an example of a preferred design, it will be understood from the description below that other shapes, sizes, etc. may also be used.

Generally speaking, LED light fixture 10 is designed to provide sufficient lighting to replace the current fluorescent fixtures of different light intensity, or lux level. Lux is different from lumens in that the lumen output is the total amount of light energy emitted from the fixture as measured by putting the fixture in a dark sphere and measure the light energy, whereas lux or foot candle is the amount of useful light hitting or reflecting from the work service due to the fixture. A general purpose light will generally have a light output of at least 800 lumens for a fixture that replaces an incandescent bulb, and will be higher for larger fixtures. For example, fluorescent light fixtures generally have a lumen output of at least 2000 lumens and may be as high as 10,000 lumens or more, depending on the size of the fixture, the power rating, and the number of bulbs. Preferably, light panels 10 are designed to produce at least 25, 30 or 50 foot-candles and as much as 80 or 100 foot-candles of light as measured at a working surface 3 m from the fixture. The following are some examples of recommended useful light level for different situations:

Classroom—300 lux or 27.9 foot candles

Technical drawing room—750 lux or 69.7 foot candles

Computer working room—300 lux or 27.9 foot candles

Lighting can range from 100 lux (9.3 ft) in, for example, general areas to 1000 lux (93 ft) in, for example, a hospital setting. Lighting guides and requirements may change between jurisdictions. Furthermore, the actual light intensity on the working surface will change depending on the height at which it is mounted, which should also be a consideration in designing an appropriate lighting fixture for a particular situation. It will be understood that light output and intensity from LED lighting cannot be directly compared to fluorescent lighting, as LED lighting is directional, while fluorescent lighting is not, and often relies on a reflective surface behind the fluorescent bulb.

The panels described herein use a direct facing LED arrangement relative to the light diffusing material to produce lighting that is particularly beneficial for general purpose lighting.

When designing the LED array and light fixture, it is desirable to achieve uniform lighting, or uniform lighting as perceived by the human eye, shining out of the panels onto the general lighted environment. In addition, it is desirable to consider the type of material, and the arrangement thereof to achieve the light effect of the panel while minimizing manufacturing costs. For example, standardized substrate construction and design for various product models may be used, the LED substrate may be shaped to support various LED models and types with different wattage and angle of light emission etc., and the specific and overall manufacturing cost of production is minimized.

The uniform lighting effect of the panel may be developed by balancing the following key elements:
a. The LED chip wattage (luminance capacity);
b. The LED chip light emission angle;
c. The arrangement of the LEDs, including the distance between each LED chip of the array of chips on the printed circuit substrate that generate the desired level of luminance;
d. The distance between the chips on the substrate and the diffusing lens covering the panel and where light shines through;
e. The angle of the light emission of the selected LED chips on the array. It should be noted that the LED chip emission angle may not be the same across the entire array to provide the desired resulting overall lighting effect;
f. The thickness of the diffuser board that acts as the lens where lights pass through in a narrow angle to the environment; and
g. The light properties of the diffuser lens material, such as refractivity, transparency, density and hardness of the material.

The development of the panels is based on balancing the relationships of the above factors to achieve a fixture that produces a light output that appears consistent to the human eye across the diffuser panel. Refinements to the design may be achieved using observations from an observer. A process that has achieved adequate results can be summarily described as follows. It will be understood that, while not mentioned, iterations of the various steps may be required if the initial parameter is unable to achieve the desired results. For example, if the first step taken is to select a LED, once the other factors have been considered, it may be necessary to select a LED with a wider light output angle or a different brightness. If the first step taken is to define the spacing requirements between LEDs, it may be necessary to reconsider these steps as part of the process.

The process preferably begins by determining the level of lumens required for a particular model of the panel, as well as the total surface area and shape of the panel. The type of LED to be used may then be selected to allow these features to be achieved. The LED is defined at least in part in terms of the luminous flux to be generated from this source. The luminous flux may be defined by the electric amperage and input voltage passing through the chip and its inherent design efficiency that determines the amount of lumens of the light to be emitted from the device. The choice of LED may be made from among a large array of market available models or from a custom designed LED. The brightness of the LED chips selected will determine the total number of chips required to achieve a desired luminous flux from the fixture as a whole, as well as the number of LED chips that can be placed on the PCB board related to the overall size of the fixture.

Both the angle of the light emitted from the LED and the LED light color may form part of the selection process. The light emitted is generally brighter toward the center of the LED, and diminishes as the angle increases. For example, the viewing angle, or light output angle of the LED, may be considered the angle in which 80% of the light is emitted. LEDs may emit light at an angle of about 60 degrees as measured from the center (i.e. a total viewing angle of 120 degrees) with a concentrated band of light, i.e. the viewing angle or light output angle, around 40 degrees from center. The viewing angle of other LEDs may be more or less than this. An example of this can be seen in FIG. 7, where the wider lines represent the total light that is emitted, and the more narrow lines represent the light output angle.

Once the parameters of the LEDs are known, the number of LED chips and the layout of the LED chips may then be designed across the panel to achieve the desired lumen level from the output of the light fixture as a whole. The distance between individual LED chips on the supporting printed circuit board (PCB) may then also be determined as well as the distance between the LED array and the light diffusion panel. It will be understood that these factors may be determined in a different order than what is described in the preferred method herein. For example, the spacing of the LEDs may be set at the beginning, and the LED output angle and brightness determined from that.

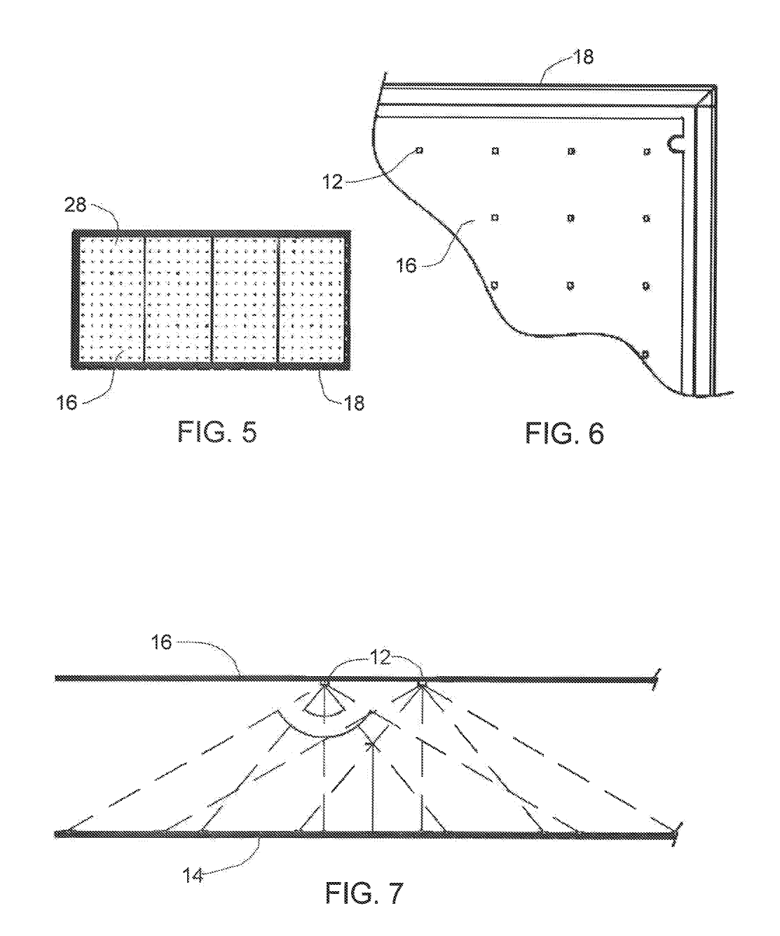

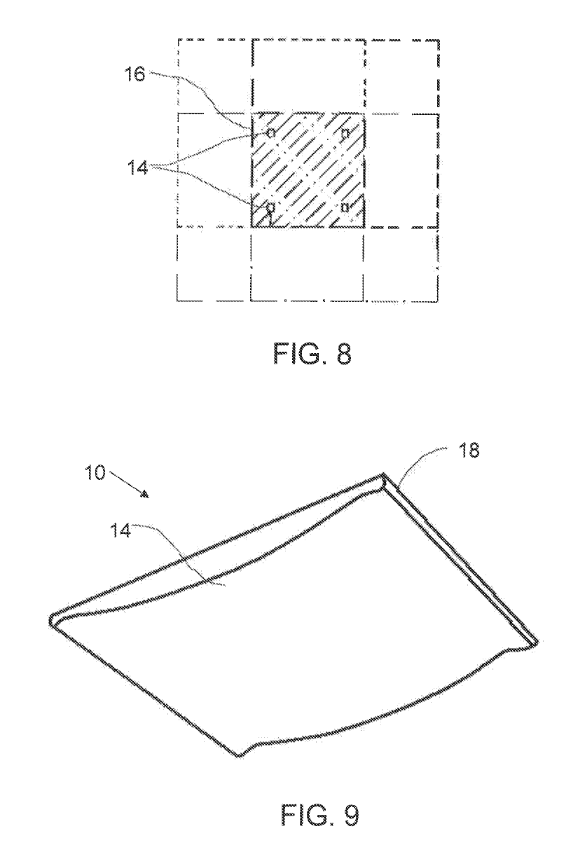

Referring to FIG. 7, the LEDs 12 are positioned on the PCB panel 16 such that the light is emitted toward the light diffusion panel 12. Preferably, the center of the cone of light that is emitted from each LED chip is perpendicular to the light diffusion panel. Referring to FIGS. 5 and 6, a distribution of the LEDs 12, preferably in the form of chips, is shown. Referring to FIG. 7, the distribution is primarily determined by the light angles of each LED 12 and the physical separation of the LEDs 12. The final layout will be mapped with a network of printed circuit wiring connecting the chips resulting in the optimum numbers of clusters of LED chips that will both minimize any impact of pre-matured cluster failure and minimize the cost of printed circuit aluminum strips required. In FIG. 8, the output of each LED is depicted by a square for illustrative purposes, although the light output is more likely to be circular, with the light output of adjacent LEDs 12 overlapping. It can be seen that the result is a brighter, more uniform light output from the diffuser panel in the area of the overlap.

The distance between individual LED chips 12 on the PCB 16 determines how emitted light overlaps at a distance from the chips, and more particularly, on diffusion panel 12. Generally speaking, the density of lumens hitting the surface of the diffuser 12 is inversely proportional to the square of the distance between the individual LED chips 12 and the surface of the diffuser or lens 12. By spacing the LED chips 12 further apart, the overlap area will be smaller for a given distance between the PCB board and the chips and therefore making the overlap areas more light concentrated. Conversely, by decreasing this spacing, the overlap area will result in a lower concentration of light. For every combination of luminous flux for a particular LED chip, there will be a range of light concentration in the overlap area that results in the light emitted from the diffuser (which may be referred to as the lens of the light fixture) to look smooth across the overlap area and correspondingly across the whole surface of the diffuser, or lens. This range is determined by the gradual decrease of the luminous flux across the overlap area based on the inverse distance square ratio. For example, in one embodiment the optimum distance between the chips on the rows was determined to be 35 mm, and the range of visible smooth diffuser surface light was found to be the ring of 9 mm surrounding the strong light circle of 80 degrees from each chip on the diffuser surface. These dimensions are for illustrative purposes only, and other dimensions may be used based on the principles described herein.

Referring to FIG. 6, another factor to consider is the distance of the outermost rows of the LED chips 12 from the edge of the supporting frame 18. The light output along the edges of LED fixture 10 is preferably consistent with the rest of fixture 10 and the distance must be properly determined in order to achieve this result. This distance is determined by the overlap area of light between rows of LED chips as laid out on the PCB 16. In one example, where the spacing of LEDs in the array was 35 mm, the optimum distance of the outermost marginal row of LED chips 12 from the frame 18 was found to be 17.5 mm, that is, the radius of the concentrated circle of luminous flux from the chip on the surface of the diffuser, and about half the distance of the spacing between the LED chips. As will be understood, if the distance between the LED chips is very small, this will be more difficult to achieve.

Referring to FIG. 7, the spacing of the LED chips on the substrate is also related to the distance of the PCB board 16 from the diffuser (or lens) 12 of the LED fixture 10. This distance, in combination with the distance between the LED chips 12 on the PCB board 16 and the light angle of the LEDs 12, provides the desired amount of overlap of the light on the diffuser in respect of visible smooth light surface and maximum penetration of the light generated from the LED lights. As discussed, the luminous flux hitting the surface of the diffuser or lens from the chips on the PCB board is inversely proportional to the distance of the PCB from the diffuser. The distance between the substrate 16 and the diffuser 12 is related to the overlap area of light between rows of LED chips as laid out on the PCB, the light angles of the LED chips, the light intensity of the chips, and the thickness and refractory characteristics of the diffusion panel. The spacing is selected to cause the light passing through the diffusion panel appears uniform to the human eye. This distance is guided by mathematical estimation of these factors and, when necessary, careful manual adjustments based on human eye perception until the whole shining surface area exhibit a consistent lighting across the entire panel. The final arrangement is preferably tested using a light meter to measure pre-determined spots across the panel to achieve within a tolerance of light emission range designed such that the light output appears uniform to the human eye. This consistent light output may be contrasted to a fluorescent lighting fixture with elongated light bulbs that are visible through the diffusion screen, producing a pattern of light and dark areas from the diffusion screen.

For example, for LEDs with a smaller light output angle, the LEDs must be positioned closer together in order to achieve a uniform distribution of light from the diffusion panel. As the density of the LEDs on the panel increases, this will increase the lumen output of the light fixture, which may require LEDs that are not as bright, depending on the desired result. In addition, the flux of the LED will decrease as the distance from the LED increases, while the overlap of adjacent LEDs increases.

In some circumstances, the light fixture may have a curved diffuser. The curvature of the diffuser relative to the curvature of the LED chip mounted board will relate to the effective distance of the chips from the surface of the diffuser. This distance is maintained to provide the optimum luminous flux on the overlap area on the diffuser and to provide the appearance of a continuous light output. In other circumstances, the LED fixture and the diffuser may have other shapes aside from rectangular. The same method of designing the LED fixture can be adapted to any practical shape of fixture including curved shining surfaces, different shapes and sizes to accommodate modern architectural requirement of uniform lighting from LED for general lighting. This can be accomplished by maintaining the distance of the LED chips on the PCB board that follow the shape of the LED fixture and maintaining the distance of the outermost row of the LED chips from the edge of the diffuser, or frame of the LED fixture.

Based on the surface area of the shining surface of the panel, the size and thickness of the optimum light diffuser board may be determined. A suitable diffuser board may be made from a composite material of polymer and glass fiber, or from a polycarbonate/acrylic material. In one example, a panel made from polymethyl methacrylate that was 2 mm thick was used. These materials may be designed with varying amounts of hardness and light refractory characteristics. A sufficient hardness and thickness is required for the structural integrity of the overall panel and refractory characteristics, which are also related to the thickness, are selected in order to cause the light to be transmitted evenly across the diffuser board. It has been found that beneficial results may be had using a diffuser with a tensile strength of over 50 MPa, a bending strength of over 110 Mpa, and an impact resistance of over 1.7 KJ/m square. Similarly, beneficial results may be had when the chemical and performance characteristics include a light penetration rate of over 65%, light opacity of 99%, a moisture absorption rate at less than 0.1%, a shape retention temperature of more than 100° C. with an operating temperature of less than 85° C.

The panels are also preferably designed in order to minimize manufacturing costs, such as minimizing costs associated with the following:
a. Material type, amount and standardization for various product designs;
b. Labour content in the ease and sequencing of product assembling;
c. The level of manufacturing support such as the making of molds, standardizing of assembling methods for the various product models;
d. Leveraging of standardized parts in the acquisition of supplier parts
e. The optimization of packaging to minimize the handling and cost of transportation;
f. The selection of material to minimize the impact of duties on some material in the importing into North America; and
g. The ease and consistency of inspection and electrical appliance certification of the product that include the design in of certified parts, etc.
   This minimization also includes targeting specific flux densities, such that no more LEDs than necessary are used, including maximizing the spacing of LEDs, while still meeting the desired specifications and a light output that appears consistent to the human eye across the light diffusion panel.

The LED panels are preferably powered using drivers, such as those described below. These drivers may be used to drive each LED panel individually, or a single driver may be used to drive a plurality of panels. By doing so, it is possible to have a single driver drive lighting fixtures in a particular area. The drivers may also control the voltage applied to the light panels, such that the lights may be dimmed or brightened, either on demand or according to a predetermined schedule.

### Example of Design Process

The process of designing the Direct Light LED panel can be generalized in the following steps.

First, considering the amount of lumens that are required for the resultant LED fixture and the size and shape and shape of the fixture diffuser, the correct model and number of the LED light source units (chips) are selected. This is preferably done from a number of market available models that would provide the correct luminous flux at a suitable wattage consumption with high conversion efficiency.

Next, the PCB network arrangement is developed for the wiring connection for the number of LED light source units (chips) to maximum the reliability of maximum luminous flux from the network of light source units in case some of them would fail. A number of optimizing methods can be applied to the design of PCB network wiring employing both cluster arrangement, parallel and serious connections of the chips.

Then the optimum layout of the LED light source units on the PCB network is determined, in consideration of the spread of luminous flux associated with the LED emission angle and the optimum distance between the LED light source from the diffuser while controlling the correct ratio of the strong light and weak light overlap areas on the diffuser surface as discussed in the above factors considerations. A sectional modeling method may be employed using LED light source with mathematical calculation for the initial distances as a first optimization step.

In finalizing the layout of the LED light source network on the PCB, the distance of the outermost rows of the LED chips from the edge of the LED diffuser or the frame of the fixture may be considered.

For diffuser surface that has a curvature, the critical distances are considered that are between the LED light sources on the network and between the LED light source from the diffuser surface. This may be done by modeling in a sectional manner the distances while maintaining the optimum ratio of the overlap areas between the strong light flux (such as a LED with an output of 80 degrees) and the weak light flux (such as a LED with an output of 120 degrees) on the diffuser surface. Generally, the strong light flux may be considered the area in which 80% of the luminous flux from the LED is evenly emitted. This may change between different types of LEDs.

The resultant network of LED light source may then be modeled while considering the manufacturability of the LED panel for the most likely sizes and luminous flux requirement. That is, the modular sections of LED PCB modules are developed using a somewhat uniform network to satisfy a broad range of luminous flux requirement and dimensions of most likely fixtures in actual lighting environment. For example, using the principles discussed herein, modular sections of the LED PCB network have been developed that encompass the most flexible and reliable wiring while being able to accommodate a broad range of numbers of LED light source (chips) to be mounted on the same module while producing different total luminous flux, for different sizes of resultant LED fixtures. These can be used to manufacture LED panels using assembled groups but different number of the same modules to provide a range of 40 watts, 60 watts, and 72 watts of LED panel fixtures for the common sizes of 4 feet by 2 feet, 4 feet by 1 foot, and 2 feet by 2 feet fixtures. This is done to facilitate the manufacturability of the panels and reduce costs for the ultimate users.

### Other Considerations

The structure of the LED panel 16 can be designed in a number of ways using traditional methods both for the complete LED panel units 10 or for the retrofit kits that can be used to convert existing fluorescent fixture into LED fixtures 10.

Modifications to product specifications, instructions, limitations, warnings, etc. may be modified to fit various circumstances as will be recognized by those skilled in the art. The design principles used to develop the examples described herein may be generalized to develop other products according to the preferences of the customer or manufacturer.

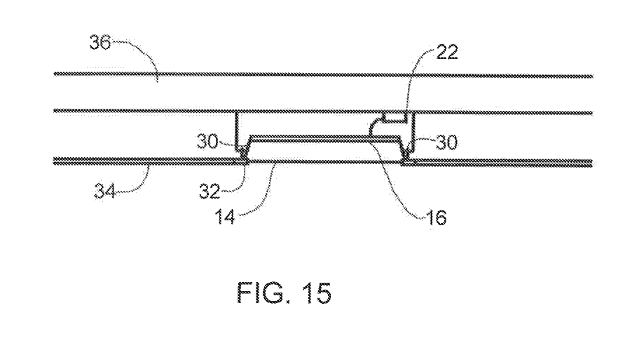

The LED panel 16 may be constructed in a box or frame with a back panel, or the array of LEDs may be suspended in other ways above the light diffuser panel. The LED panels may be designed to replace current lighting fixtures, such as fluorescent bulb lighting fixtures. This may be done by removing the existing lighting fixture and installing the LED lighting fixture, or the LED lighting panel may be designed to fit within the lighting fixture. The LED panel may also be retrofitted into a fluorescent light fixture by removing the bulbs and the ballasts if necessary and fitting the LED panel into the fixture. Alternatively, referring to FIG. 15, LED panel 16 may be designed with supports 30 that support the LED panel 16 for example, within an existing lighting fixture being retrofit, on the rails 32 of a suspended ceiling 34 as shown, etc. For example, supports 30 may be legs that extend downward and outward from LED panel, such that they are compressed when inserted into a hole in the ceiling, a lighting fixture housing, etc. and spring outward to engage a lip or other surface. LED panel 16 is relatively light and can therefore easily be supported by various existing structures. Driver 22 is preferably secured in place, either to the existing fixture, to the ceiling beams 36 as shown, or other rigid structure, and then electrically attached to panel 16. Diffuser 14 may be mounted in any convenient manner.

It will be also understood that the retrofitted designs discussed above may also be used for fixtures that do not have a diffuser panel that produces continuous output of light. For example, the design of LED panel 16 and its spacing from diffuser panel 14 may not be designed to produce such a result, or the diffuser panel 14 may not be capable of producing such a result. As an example, acrylic covers that are normally used on fluorescent light fixtures may be used instead of the diffuser panel described above.

The LED panel is also preferably designed in order to dissipate heat. For example, the LEDs may be mounted to a heat conducting strip in order to maintain the LEDs within a predetermined temperature during operation.

The LEDs may be spaced closer in one direction than in the other. This is done such that a power source may connect the LEDs with a reduced amount of material used to construct the LED panel. However, it has been found that beneficial results are obtained when the distance between the rows and the columns is within 10% of each other. If the ratio of this distance is increased, less of the row and column chips would overlap at the diffuser surface within the 80 degree area. Conversely, if this ratio is decreased, more the chips in the row and the columns would overlap within the 80 degree area. It has been found that with the ratio maintained within 10%, the overlap areas and the light intensity (flux) falling on the diffuser surface is such that the normal human eyes would not be able to differentiate a difference in the light intensity coming through to the other side of the diffuser.

It will be understood that the LED array need not be linear or regularly spaced. In particular, the array may depend on the type of LED used and the location of the LEDs in the array relative to the lighting fixture. Furthermore, the array and the light diffusing panel may be non-linear, such as defining a curved shape, or a wavy shape. It will be understood that, even with non-linear shapes, the array is designed to produce a consistent light output, which will generally require the LED array to be consistently spaced from the light diffusing panel along the non-linear shape.

### Exemplary Light Fixture

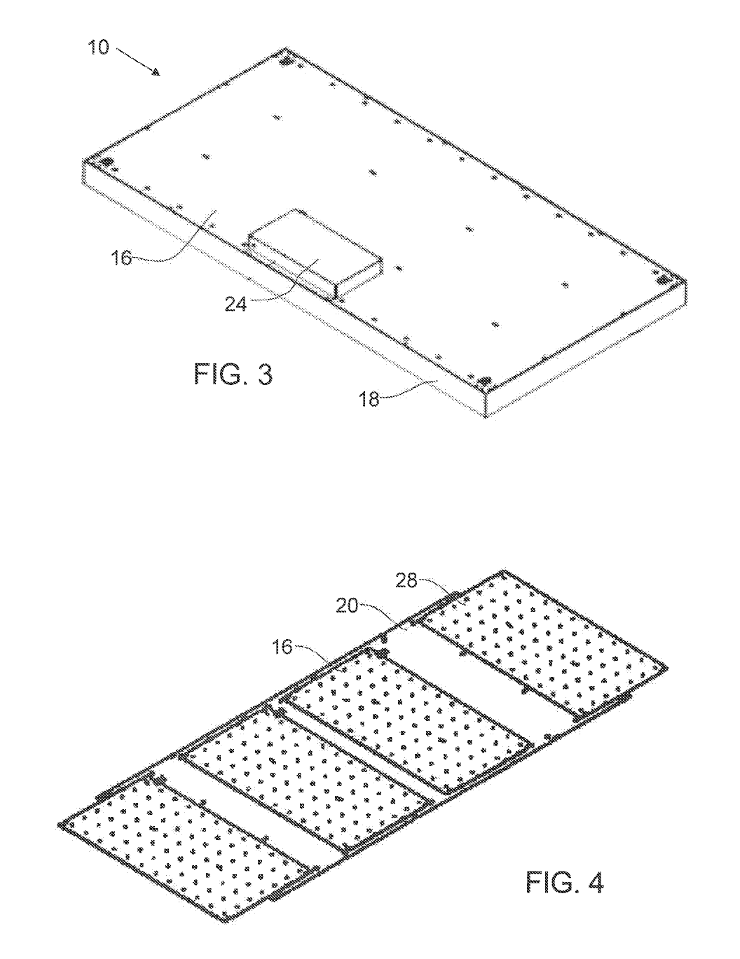

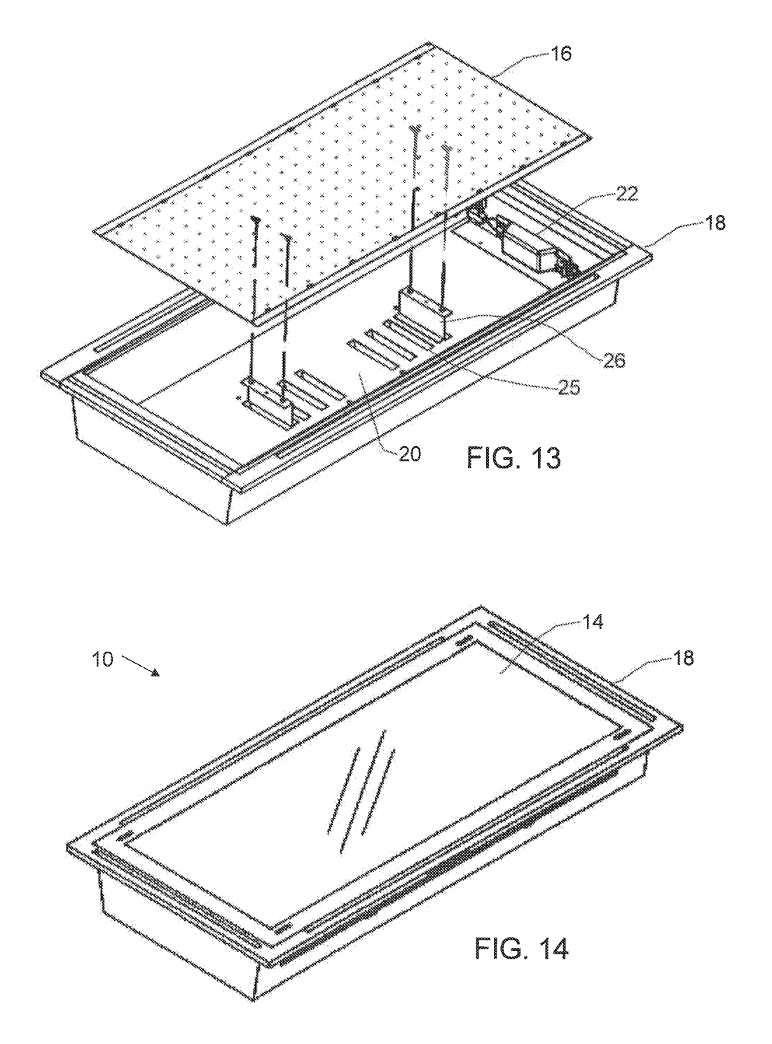

There will now be described examples of light fixtures. Referring to FIGS. 1-3, LED light panel, generally indicated by reference number 10, uses LED light sources 12 that impinge directly on the diffuser 14. As described previously, the LED lights 12 are considered point sources but are designed to emit light evenly and directly onto diffuser 14. LED lights 12 are mounted to a PCB 16, or other suitable substrate. PCB electrically connects LED lights 12 to a power source, such as a driver 22. LED lights 12 may be part of a chip that is attached using known methods. PCB 16 preferably has heat sinks (not shown) such as copper foils in order to improve heat dissipation from the LEDs. PCB 16 and diffuser 14 are preferably mounted in a frame 18, such as an aluminium frame or other suitable material. Preferably, frame 18 is designed with a higher heat conductivity to act as a heat sink for any heat generated by LEDs 12. In some embodiments, referring to FIG. 4, PCB 16 may be mounted to a back plate 20, which provides structural strength to PCB 16, such as when PCB 16 is modular as will be described below, or, referring to FIG. 13, when being retrofitted into an existing fixture. PCB 16 and/or back plate 20 may have vent holes 25 to allow air to circulate and remove any excess heat generated by the LEDs.

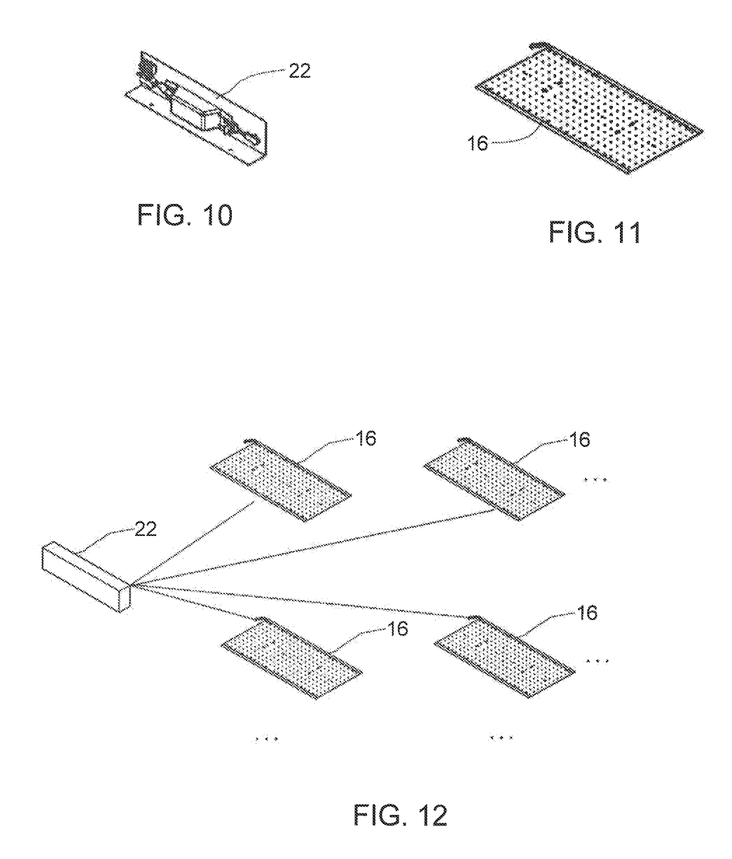

Referring again to FIG. 1, there is shown a power driver 22, which may be covered by a cover plate 24. Light diffuser 12 serves to diffuse the LED light that shines onto it, and is preferably mounted to the same frame 18 as the PCB 16. PCB 18 may be attached to back plate 20 using a mechanical attachment, such as screws, and back plate 20 may in turn be fixed to frame 18 using a mechanical attachment, such as screws. Power driver 22 is shown as being secured to the opposite side of back plate 20 compared to LED lights 12. In some circumstances, referring to FIGS. 10 and 11, driver 22 may be electrically, but not structurally, connected to PCB 16. Referring to FIG. 12, this may also be useful if a single driver 22 drives LEDs on multiple PCBs 16. Preferably, driver 22 is designed with quick-connect electrical connectors in order to facilitate installation and replacement.

Driver 22 may be attached in different ways to light panel 10. For example, referring to FIGS. 13 and 14, when retrofitting an existing fluorescent light fixture, driver 22 may be designed to take the place of the existing ballast, which is removed. As depicted, the ballast and the connections for the fluorescent lights have been removed from frame 18. Driver 22 is mounted within frame 18, and is preferably designed to be mounted to the holes that previously held the ballast. At the same time, spacer elements 26 are used to mount PCB 16 within frame 18. Spacer elements 26 are used to ensure a proper spacing between the LEDs carried on PCB 16 and diffuser panel 14, as the depth of the existing frame 18 is likely much greater than what is required for the light panels 10 described herein. Spacer elements 26 are also designed to attach to existing holes in frame 18. In this manner, a fluorescent light fixture may be retrofitted to become a light panel 10 as described herein within a very short period of time and using standard tools.

Referring to FIG. 4, PCB 16 may be designed with multiple, modular panels 28. This helps keep manufacturing costs lower by allowing common components to be assembled into various sizes of light fixtures.

In one example, a light panel was designed with 3528 SMD LEDs, each having a beam angle of 120 degree, a luminous flux of about 6.5 lm. The LEDs were arranged in a dot-matrix distribution with a modular construction on separate PCBs. The LEDs selected provide less than a 3% loss of light output after 1000 continuous hours of lighting with a steady luminous flux output. The LED chips chosen were about 2 mm thick, and the distance between the LEDs 12 and the diffuser 14 was less than or equal to 52.5 mm. The distance between LED chips was less than or equal to 35 mm, with the difference in the between rows and columns of LEDs being less than 10%. The distance between LED chips on the periphery of the array and the frame 18 was less than or equal to 17.5 mm.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. The scope of the claims should not be limited by the preferred embodiments set forth in the examples, but should be given the broadest interpretation consistent with the description as a whole.

What is claimed is:

1. A method of designing a lighting panel having an LED array spaced from a light diffuser panel, the method comprising the steps of:
determining a level of lumen output to be achieved from the lighting panel;
selecting one or more types of LEDs having a predetermined light intensity and light output angle;
calculating the number of LEDs required to achieve the level of lumen output;
arranging the LEDs in an array, the LEDs being oriented such that the light output angle is centered on the light diffuser panel, the LEDs being spaced in the array and being spaced from the light diffuser panel such that the light output from the LEDs overlaps on the light diffuser panel such that the light transmitted through the diffuser panel appears consistent across the light diffuser panel to the human eye and achieves the determined level of lumen output.

2. The method of claim 1, wherein the LEDs are in a regular rectangular array.

3. The method of claim 2, wherein the LEDs are spaced closer in a first direction than in a second direction.

4. The method of claim 2, wherein the spacing of the LEDs in a first direction is within 10% of the spacing of the LEDs in a second direction.

5. The method of claim 1, wherein the LEDs are connected to a common power supply.

6. The method of claim 1, wherein the LED array defines a plane.

7. The method of claim 1, wherein the diffuser panel defines a curved surface.

8. The method of claim 1, wherein the LED array defines a rectangular shape.

9. The method of claim 1, wherein the LED array defines a curved shape.

10. The method of claim 1, wherein the LED array is mounted to a modular substrate.

11. A lighting panel having an LED array, comprising:
a light diffuser panel;
an array of LEDs having a light intensity and a light output angle, the LEDs being oriented toward the light diffuser panel such that the light output angle is centered on the light diffuser panel, wherein the spacing of the LEDs within the array and the spacing of the LED array from the light diffuser panel produce a light output from the light diffuser panel that appears consistent to the human eye across the light diffuser panel.

12. The lighting panel of claim 11, wherein the LEDs are in a regular rectangular array,

13. The lighting panel of claim 12, wherein the LEDs are spaced closer in a first direction than in a second direction.

14. The lighting panel of claim 12, wherein the spacing of the LEDs in a first direction is within 10% of the spacing of the LEDs in a second direction.

15. The lighting panel of claim 11, wherein the LEDs are connected to a common power supply.

16. The lighting panel of claim 11, wherein the LED array defines a plane.

17. The lighting panel of claim 11, wherein the diffuser panel defines a curved surface.

18. The lighting panel of claim 11, wherein the LED array defines a rectangular shape.

19. The lighting panel of claim 11, wherein the LED array defines a curved shape.

20. The lighting panel of claim 11, wherein the LED array is mounted to a modular substrate.
